(19) United States
(12) Patent Application Publication
(10) Pub. No.: US 2012/0228926 A1
(43) Pub. Date: Sep. 13, 2012

(54) TRACK ASSEMBLY WHEEL

(76) Inventor: Larry Bair, Louisburg, KS (US)

(21) Appl. No.: 13/415,343

(22) Filed: Mar. 8, 2012

Related U.S. Application Data
(60) Provisional application No. 61/450,678, filed on Mar. 9, 2011.

(51) Int. Cl. B62D 55/14; B23P 11/00

(52) U.S. Cl. 305/136; 29/894

(57) ABSTRACT

A method of modifying a track assembly wheel includes removing at least a portion of the wheel from the track assembly including a first disc, securing a second disc to the wheel on a first side of the first disc to create a modified track wheel, and replacing the modified track wheel on the track assembly such that the wheel engages a continuous track of the track assembly and an alignment mechanism of the track, the wheel being positioned such that a portion of the alignment mechanism is between the first disc and the second disc such that the first disc engages a first side of the portion of the alignment mechanism and the second disc engages a second side of the portion of the alignment mechanism.

### RELATED APPLICATION

This non-provisional patent application claims priority benefit with regard to all common subject matter of earlier-filed U.S. Provisional Patent Application No. 61/450,678, filed Mar. 9, 2011, and entitled METHOD AND APPARATUS FOR INSTALLING A MODIFIED WHEEL ON A CTL UNDERCARRIAGE. The earlier-filed provisional application is hereby incorporated by reference in its entirety into the present application.

### BACKGROUND

1. Field

Embodiments of the present invention relate to track assembly wheels for machines that use continuous tracks, such as vehicles that use continuous tracks for propulsion. More particularly, embodiments of the present invention relate to a wheel for use in a track assembly, the wheel including a plurality of discs for engaging a continuous track at multiple, transversely spaced locations.

2. Related Art

Machines that use continuous track assemblies are known in the art and include, for example, tracked vehicles such as compact track loaders, bulldozers, tractors, and other excavation and agricultural equipment. Typical continuous track drive assemblies include a track frame, a plurality of wheels or rollers mounted on the frame, and a continuous track rotatably mounted on the plurality of wheels in a circumscribing relationship to the wheels and frame. The plurality of wheels may include a drive wheel or sprocket driven by a motor to induce rotational movement in the track, a plurality of bogie wheels for supporting the vehicle on the track, and one or more idler wheels. The idler wheels engage the track and passively rotate to guide the track along a desired path defined in part by a radially outer portion of each of the idler wheels. Idler wheels, for example, may be placed on one or both ends of the track assembly, while a series of bogie wheels may be positioned in or near a center portion of the track assembly.

The track assembly may include a tensioner for tightening the track against the wheels during operation and for releasing the track for repairs or removal. The track may include a guide or alignment mechanism to ensure that the track remains properly positioned on the wheels during operation of the machine. By way of example, a series of guide lugs or similar mechanical elements may be positioned on the inside of the track for engaging at least some of the track assembly wheels. Such guide lugs may be arranged in one or more longitudinal rows, such that the track assembly wheels engage the guide lugs as they roll against the track to prevent lateral movement of the track relative to the wheels.

Interaction of the wheels and the alignment mechanism can result in premature wear or damage to the wheels, the track, or both, particularly when the track is subject to forces applying substantial lateral pressure on the track. For example, if the guide lugs are not properly aligned with one or more of the track assembly wheels, the guide lugs may rub the wheels with excessive pressure potentially causing damage, premature wear, or overheating due to friction.

Accordingly, there is a need for a track assembly which overcomes the limitations described above.

### SUMMARY

A method of modifying a track assembly wheel in accordance with an embodiment of the invention comprises removing at least a portion of the wheel from the track assembly, the removed portion of the wheel including a first disc, and securing a second disc to the wheel on a first side of the first disc to create a modified track wheel. The modified track wheel is replaced on the track assembly, such that the wheel engages an alignment mechanism of the track, the wheel being positioned such that a portion of the alignment mechanism is between the first disc and the second disc and such that the first disc engages a first side of the portion of the alignment mechanism and the second disc engages a second side of the portion of the alignment mechanism.

A track assembly in accordance with another embodiment of the invention comprises a continuous track, the track including an alignment mechanism defining an inner longitudinal channel spanning at least a portion of the length of the track, and a plurality of wheels engaging the track. At least one of the wheels includes a unitary wheel body including a first disc section, a second disc section, and a neck portion, the first and second disc sections being in axial alignment and separated by the neck portion, and an annular element not integrally formed with the unitary wheel body but attached to the neck portion such that the annular element is laterally separated from the first disc section by a space and is laterally separated from the second disc section by a space.

The wheel is positioned on the track assembly such that the first disc section, the second disc section, and the annular element engage the alignment mechanism, wherein the annular element engages the alignment mechanism inside the channel, the first disc section engages a first side of the alignment mechanism outside the channel, and the second disc section engages a second side of the alignment mechanism outside the channel, the second side of the alignment mechanism being opposite the first side of the alignment mechanism.

A method of modifying a track assembly wheel in accordance with yet another embodiment of the invention comprises removing at least a portion of the wheel from the track assembly, the removed portion of the wheel including a unitary body with a first disc section, a second disc section, and a neck portion separating the first disc section and the second disc section by a space. The method further comprises securing an annular element to the neck portion of the body, such that the annular element is laterally separate from the first disc section by a space and is laterally separated from the second disc section by a space.

The modified track wheel is replaced on the track assembly such that the wheel engages a continuous track of the track assembly and an alignment mechanism of the track, the wheel being positioned such that the annular element engages the alignment mechanism inside the channel, the first disc section engages a first side of the alignment mechanism outside the channel, and the second disc section engages a second side of the alignment mechanism outside the channel.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the preferred embodiments and the accompanying drawing figures.

### BRIEF DESCRIPTION OF THE DRAWINGS

FIG. 1 is a front perspective view of a track assembly including at least one wheel constructed in accordance with embodiments of the present invention;

FIG. 2 is a rear perspective view of the track assembly of FIG. 1;

FIG. 3 is a perspective view of a track assembly wheel constructed in accordance with a first embodiment of the invention, the wheel including a plurality of laterally spaced discs separated by spacer elements integrally formed in one or more of the discs;

FIG. 4 is a side elevation view of the wheel of FIG. 3;

FIG. 5 is a cross-sectional view of the wheel of FIG. 4 taken along line 5-5 and shown engaging a track of the track assembly including an alignment mechanism of the track;

FIG. 6 is an exploded view of the wheel of FIG. 3, illustrating the spacer elements and a plurality of bolts aligned with through holes of the spacer elements;

FIG. 7 is a perspective view of a track assembly wheel constructed in accordance with an alternative configuration of the first embodiment of the invention, the wheel including a plurality of laterally-spaced discs separated by separate spacer elements not integrally formed in any of the discs;

FIG. 8 is a side elevation view of the wheel of FIG. 7;

FIG. 9 is a cross-sectional view of the wheel of FIG. 7 taken along line 9-9 and shown engaging the track and the alignment mechanism of the track;

FIG. 10 is an exploded view of the wheel of FIG. 3, illustrating the spacer elements separated from the discs and the plurality of bolts aligned with through holes of the spacer elements;

FIG. 11 is a perspective view of a track assembly wheel constructed in accordance with a second embodiment of the invention, the wheel including a unitary wheel body with a first disc section and a second disc section separated by a neck portion, and an annular element attached to the neck portion;

FIG. 12 is a side elevation view of the wheel of FIG. 11;

FIG. 13 is a plan view of the wheel of FIG. 11, illustrating a pair of bolts used to secure sections of the annular element onto the neck portion;

FIG. 14 is a cross-sectional view of the wheel of FIG. 11 taken along line 14-14 of FIG. 12 and shown engaging the track and the alignment mechanism of the track; and

FIG. 15 is an exploded view of the wheel of FIG. 11.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention may be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

Referring now to the drawings, wherein like reference numerals designate identical or corresponding parts throughout the several views, a track assembly 10 constructed in accordance with embodiments of the invention is illustrated. The track assembly 10 broadly includes a frame 12, a plurality of wheels 14-20 supported by the frame 12, and a continuous track 22 circumscribing the wheels 14-20.

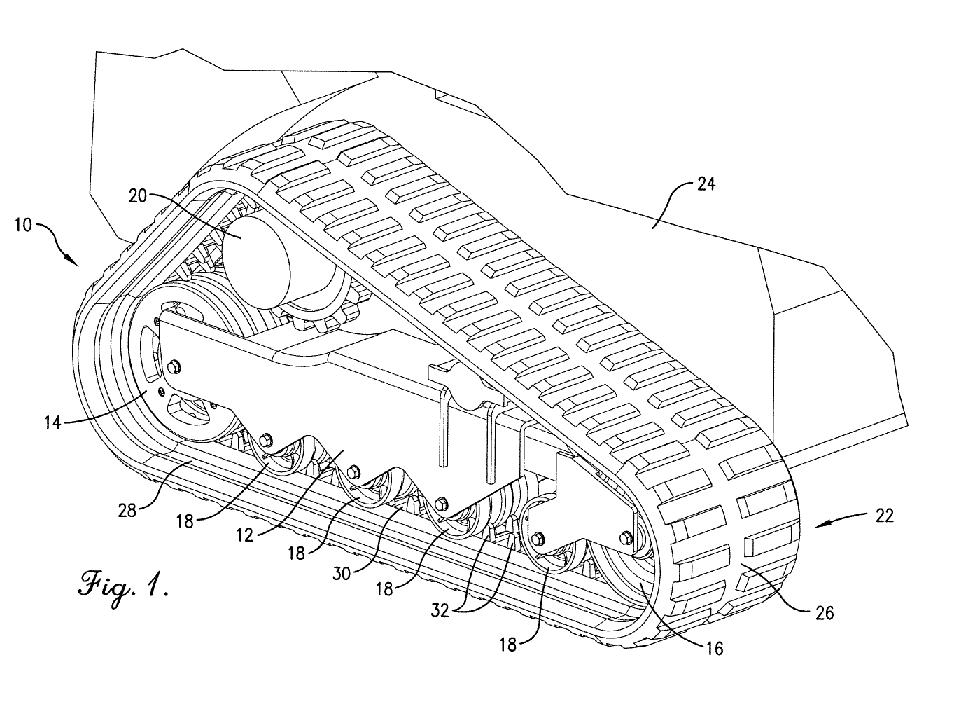

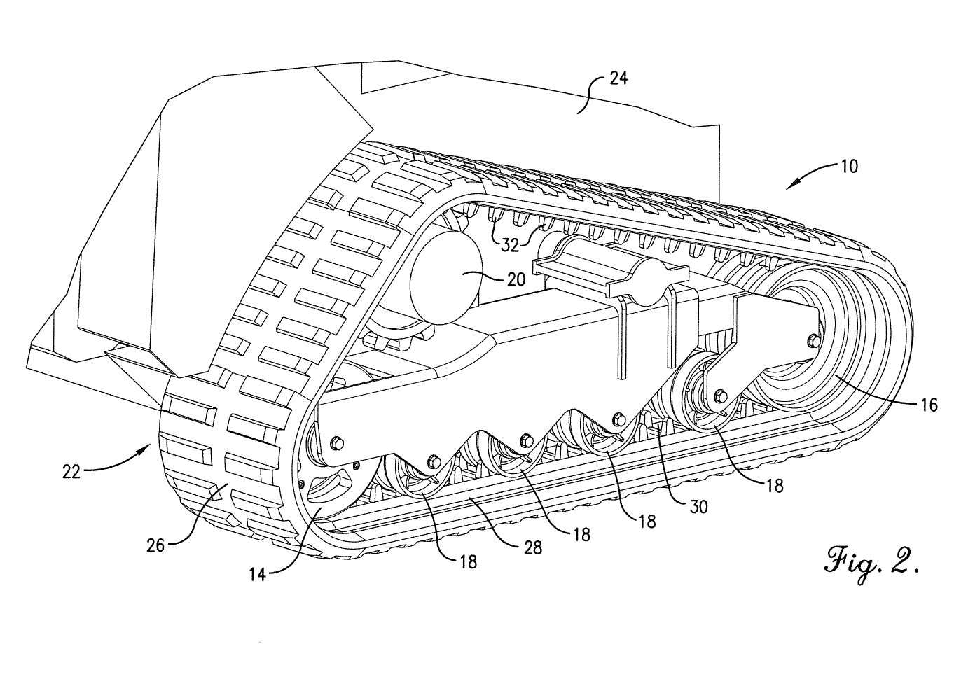

The frame 12 generally supports at least some of the wheels 14-20 relative to the machine 24 on which the track assembly 10 is operated. If the machine 24 is a tracked vehicle, for example, the frame 12 supports at least some of the wheels 14-20 relative to the vehicle, wherein the vehicle rests, at least in part, on the frame 12. The wheels 14-20 may include rollers, sprockets or other rotating elements, all of which are referred to as “wheels” herein for simplicity. If the machine 24 is a vehicle, for example, such wheels may include a drive wheel 20 or sprocket driven by a motor to induce rotational movement in the track, a plurality of bogie wheels 18 for supporting the vehicle on the track 22, and one or more idler wheels 14,16. The idler wheels 14,16 engage the track 22 and passively rotate to guide the track 22 along a desired path defined in part by a radially outer portion of each of the idler wheels 14,16. One or more idler wheels 14,16 may be placed on one end or both ends of the track assembly 10, while a series of bogie wheels 18 may be positioned in or near a center portion of the track assembly 10, as illustrated in FIGS. 1 and 2. An idler wheel 14,16 positioned on an end of the track assembly 10 defines an end curve of a path followed by the track 22.

The continuous track 22 includes an outer side 26 engaging the ground and an inner side 28 engaging the plurality of wheels 14-20. The continuous track 22 (sometimes also referred to as an “endless” track) may be constructed of a series of linked elements, such as metal planks, may be constructed of a single, unitary piece of material, such as rubber or other malleable material, or a combination thereof. The continuous track 22 includes an alignment mechanism 30 on the inner side 28 of the track 22 for engaging at least some of the wheels 14-20 and maintaining the track 22 in alignment with the wheels 14-20 during operation of the machine 24. The track may further include a series of ribs or flanges following a longitudinal path along the inside of the track 22 and configured to matingly engage a sprocket portion of the drive wheel 20. In the illustrated embodiment, the series of ribs are positioned inside a channel defined by the alignment mechanism 30, as explained below.

The alignment mechanism 30 includes one or more inwardly extending elements 32 that define, or are aligned with, one or more longitudinal paths of the inner side 28 of the track 22. The inwardly extending elements 32 may be substantially continuous, such as a continuous flange or rail, or may be defined by a series of elements, such as a series of guide lugs 32 or cleats arranged in a row along each of the one or more longitudinal paths. The alignment mechanism 30 may define a longitudinal channel 34, such as where the alignment mechanism includes two parallel rails or two parallel rows of guide lugs 32. In the illustrated embodiment, the alignment mechanism includes two rows of guide lugs 32 positioned on parallel longitudinal paths to define the longitudinal channel 34 between the rows.

At least one of the wheels 14-20 is configured to engage the track 22 at multiple, transversely spaced points on the track 22. In particular, such wheel or wheels is/are configured to engage both a first side and a second side of at least a portion of the alignment mechanism 30, thereby increasing the area of contact between the wheel and the alignment mechanism 30. In the illustrated embodiments, at least the rear idler wheel 14 is configured to engage the track at three points, including a first point inside the channel 34, a second point on a first side of the alignment mechanism 30 outside the channel 34, and a third point on a second side of the alignment mechanism 30 outside the channel 34 and opposite the first side of the alignment mechanism. Thus configured, the wheel 14 engages both sides of the alignment mechanism 30 and, in the illustrated embodiment, both sides of each row of guide lugs 32.

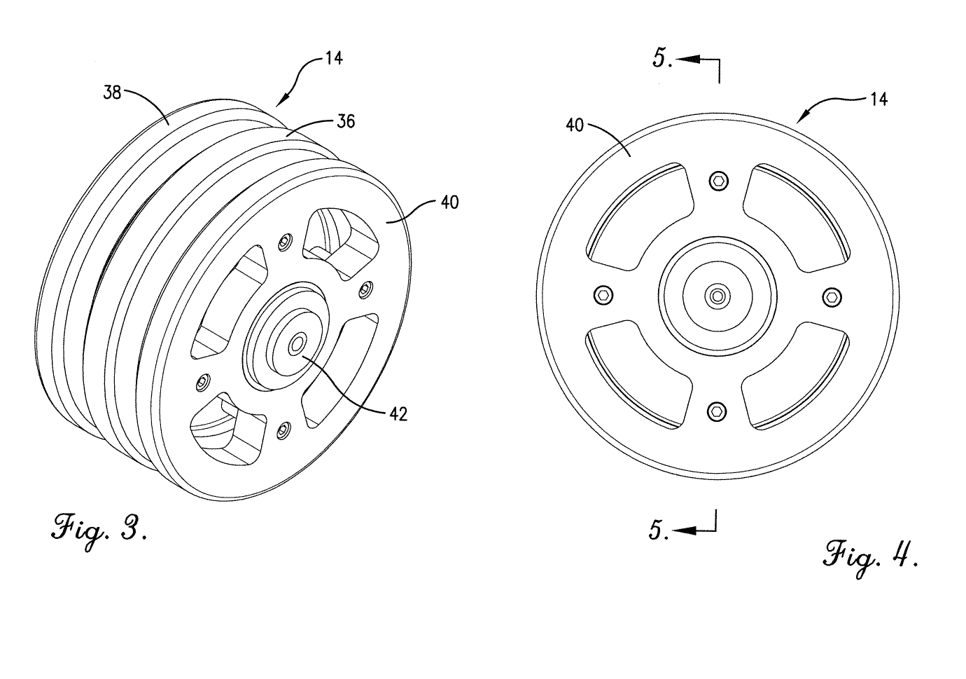

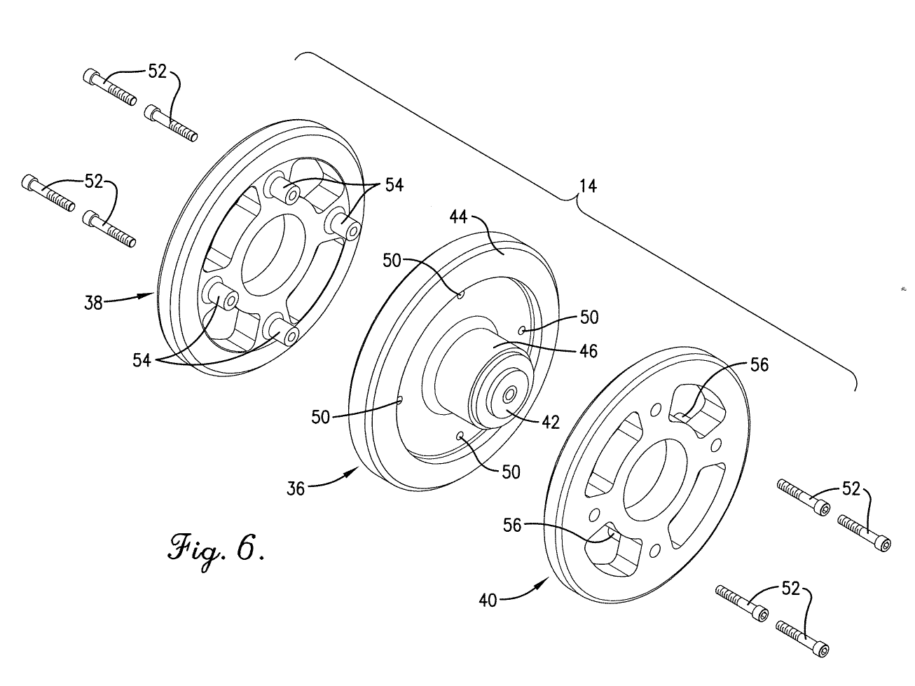

In a first embodiment of the invention illustrated in FIGS. 3 through 6, the wheel 14 includes a plurality of discs rotatably mounted on the track assembly 10. In particular, three separate discs 36,38,40 are rotatably mounted on a transverse shaft or axle 42 supported by the frame 12. A first disc 36 includes a central disc portion 44 and an axle portion 46 extending transversely from a center of the disc portion 44. A transverse through hole 48 in the axle portion 46 receives the transverse shaft 42. A plurality of threaded recesses 50 receive and engage bolts 52 for securing the second disc 38, the third disc 40, or both to the first disc 36, as explained below in greater detail. A second disc 38 and third disc 40 each may be mounted on the axle portion 46 of the first disc 36 or, alternatively, may be mounted directly on the transverse shaft 42. In the illustrated embodiment, each of the second 38 and third 40 discs is configured with a center through hole sized to engage the axle portion 46 of the first disc 36 such that the second 38 and third 40 discs are mounted on the axle portion 46 of the first disc 36.

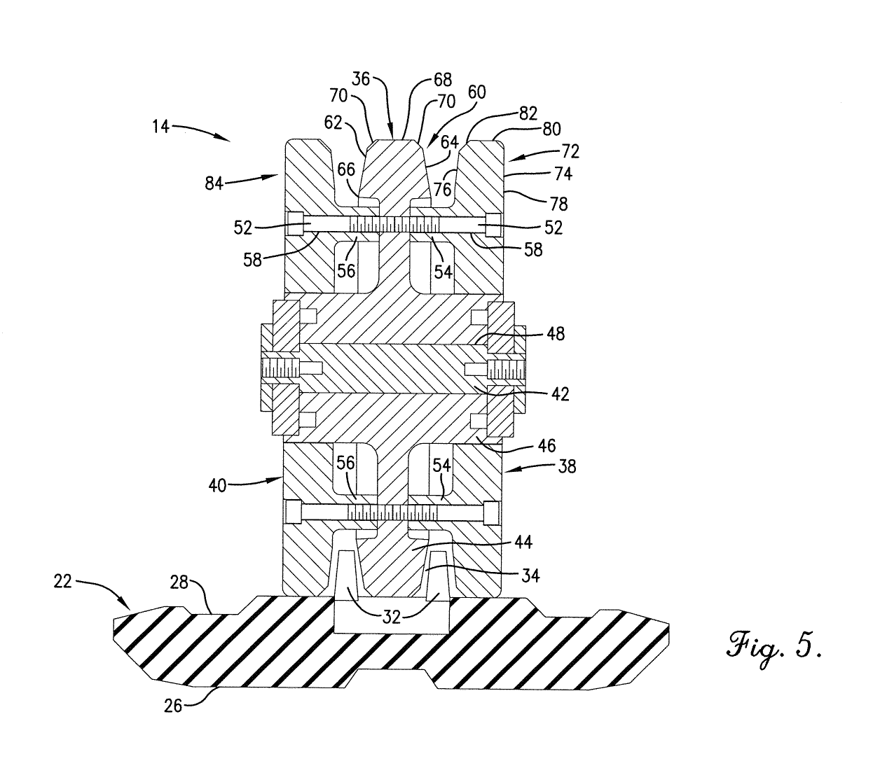

At least one and preferably a plurality of first spacer elements 54 separate the first disc 36 from the second disc 38. At least one and preferably a plurality of second spacer elements 56 separate the first disc 36 from the third disc 40. In the illustrated embodiment, four first spacer elements 54 are integrally formed with the second disc 38 and positioned between the first disc 36 and the second disc 38, and four second spacer elements 56 are integrally formed with the third disc 40 and positioned between the first disc 36 and the third disc 40. The length of the spacer elements 54,56 may vary from one embodiment of the invention to another and depends, at least in part, on the amount of space desired between the discs 36,38,40. Each of the spacer elements 54,56 presents a cylindrical shape with a through hole 58 corresponding to a longitudinal axis of the spacer element 54,56 such that the spacer element 54,56 has a generally tubular shape defined by a cylindrical wall. Each of the spacer elements 54,56 is transversely oriented such that a longitudinal axis of each spacer element 54,56 is transverse to the wheel 14, as illustrated in FIG. 5. The first spacer elements 54 are approximately evenly spaced circumferentially about the second disc 38. The second spacer elements 56 are similarly configured on the third disc 40, such that each of the first spacer elements 54 is in axial alignment with a corresponding one of the second spacer elements 56. Each of the through holes 58 extends transversely through the corresponding spacer element and disc such that an elongated fastener, such as one of the bolts 52, may be inserted through each of the spacers 54,56 and engage the first disc 36, thereby securing the second disc 38 and the third disc 40 to the first disc 36.

Each of the discs 36,38,40 may be configured to facilitate engagement with the alignment mechanism 30 during operation of the track assembly 10. In the illustrated embodiment, each disc 36,38,40 includes at least one tapered radially outer side wall, a break edge, or both. The first disc 36 includes a tapered radially outer margin 60, wherein each of a first annular lateral surface 62 and a second annular lateral surface 64 is sloped or angled inward from a base 66 of the radially outer margin 60 to a tip 68 of the radially outer margin 60 such that the base 66 is wider than the tip 68. The first disc 36 also includes opposing chamfered break edges 70 corresponding to radially outermost lateral edges of the radially outer margin 60.

A radially outer margin 72 of the second disc 38 presents a first, outer side 74 that is substantially straight and a second, inner side 76 that presents a slight inward slope or angle such that a base 78 of the radially outer margin 72 is wider than a tip 80 of the radially outer margin 72. A chamfered break edge 82 corresponds to a radially outermost inner edge of the radially outer margin 72 adjacent the second, inner side 76. The third disc 40 is configured similarly to the second disc 38, including a radially outer margin 84 of the third disc 40. While it may be beneficial and desirable for the discs 36,38,40 to include tapered portions or break edges to facilitate engagement with the alignment mechanism 30 or other portion of the track 22, it is not required for the present invention. The particular configuration of the radially outer margins of the first disc 36, second disc 38 and third disc 40 may vary substantially without departing from the scope or spirit of the invention.

In the illustrated embodiment the discs 36,38,40 are substantially uniform in diameter. It will be appreciated, however, that the relative diameter of the discs 36,38,40 will depend on the particular implementation of the invention and that the diameter of any of the discs 36,38,40 may vary relative to the diameter of the other discs 36,38,40 without departing from the spirit or scope of the invention. By way of example, the first disc 36 may be larger or smaller in diameter than the second 38 and third 40 discs.

The wheel 14 may be manufactured according to the illustrated configuration or, alternatively, may be modified from an existing wheel. In one embodiment of the invention, the wheel 14 is modified from a wheel originally manufactured and placed on the track assembly 10 with a single disc, such as the first disc 36, without the second 38 and third 40 discs. The original wheel may be positioned on the track assembly such that the single disc engages the alignment mechanism 30 inside the channel 34.

To modify the wheel 14, at least a portion of the wheel 14 is removed from the track assembly frame 12, wherein the removed portion includes at least the first disc 36. Removing the wheel 14 from the track assembly frame 12 may include, for example, relieving tension on the track 22 allowing the track to be disengaged from the wheel 14, removing a bolt or other fastener securing the shaft 42 to the frame 12, and removing the wheel 14 and shaft 42 from the track assembly 10.

The first disc 36 may be modified in preparation for mounting the second 38 and third 40 discs on the wheel 14. For example, the threaded recesses 50 may need to be added to the first disc 36 before the bolts 52 can be mounted on the first disc 36 to secure the second 38 and third 40 discs in place. Creating the threaded recesses 50 may involve using a template (not shown) to identify or mark the location of each of the recesses 50 in the first disc 36, drilling the disc 36 in the marked locations to create the recesses 50, then tapping the recesses 50 to create internal threads. The template may be constructed of plastic, metal or other durable material and may be configured to be fixed on the disc 36 with apertures corresponding to the locations of the threaded recesses. This process may be performed on each side of the disc 36 to create a series of threaded recesses on each side of the disc 36, wherein each recess extends transversely through a portion of the disc 36. Each threaded recess 50 may be in axial alignment with an opposing threaded recess on the opposite side of the disc 36, as illustrated. It will be appreciated, however, that the threaded recesses 50 need not be in axial alignment.

Alternatively, each pair of axially aligned recesses 50 may be created by drilling a single transverse through hole through the disc 36 and tapping the through hole to receive and engage two of the bolts 52 in opposing relationship. Furthermore, a machine may be programmed to create the threaded recesses 50 (or through holes, as the case may be) wherein the machine automatically performs some or all of the steps of the process. Use of a preprogrammed machine may obviate the need for a template.

The second disc 38 and the third disc 40 are secured to the wheel 14 by sliding the second disc 38 onto a first end of the axle portion 46 of the first disc 36 and sliding the third disc 40 onto a second end of the axle portion 46 opposite the first end. Each of the second 38 and third 40 discs is positioned on the axle portion 46 of the first disc 36 such that the spacer elements 54,56 extend inwardly toward the first disc 36. The bolts 52 are then inserted into the spacer element through holes 58 of the second 38 and third 40 discs and tightened into the threaded recesses 50 of the first disc 36 to secure the second 38 and third 40 discs into place on the first disc 36.

The wheel is then replaced on the track assembly frame 12 such that the first wheel 36 engages the alignment mechanism 30 inside the channel 34, the second disc 38 engages a first side of the alignment mechanism 30 outside the channel 34, and the third disc 40 engages a second side of the alignment mechanism 30 outside the channel 34. A portion of the wheel 14 need not be in constant contact with a corresponding portion of the alignment mechanism 30 to “engage” that portion of the alignment mechanism as used herein. Rather, if a portion of the wheel 14 is placed proximate a corresponding portion of the alignment mechanism 30, such that the portion of the wheel 14 contacts the portion of the alignment mechanism 30 at least intermittently during operation of the track assembly 10, then the portion of the wheel 14 is in engagement with the corresponding portion of the alignment mechanism 30. Replacing the wheel 14 on the track assembly 10 may include placing the wheel in its original position on the track assembly 10, replacing bolts or other fasteners to secure the transverse shaft 42 to the frame 12, replacing the track 22 in engagement with the wheel 14, and then applying tension to the track 22.

Alternatively, the original wheel may be modified to add only the second disc 38 to the first disc 36 such that the modified wheel 14 includes only two discs. The method for modifying the wheel 14 to include two discs is similar to the method for modifying the wheel 14 to include three discs, explained above, except that only the second disc 38 is added to the first disc 36. If an original wheel is modified to include only two discs, the modified wheel may be placed on the track assembly 10 such that a portion of the alignment mechanism 30, such as a single row of guide lugs 32, is between the first disc 36 and the second disc 38, wherein the first disc 36 engages a first side of the portion of the alignment mechanism 30 and the second disc 38 engages a second side of the portion of the alignment mechanism 30. If the wheel 14 is modified to add the second disc 38 to the first disc 36, for example, the wheel 14 would be replaced on the track assembly such that the first disc 36 engages the alignment mechanism 30 inside the channel 34 and the second disc 38 engages a side of the alignment mechanism 30 outside the channel 34.

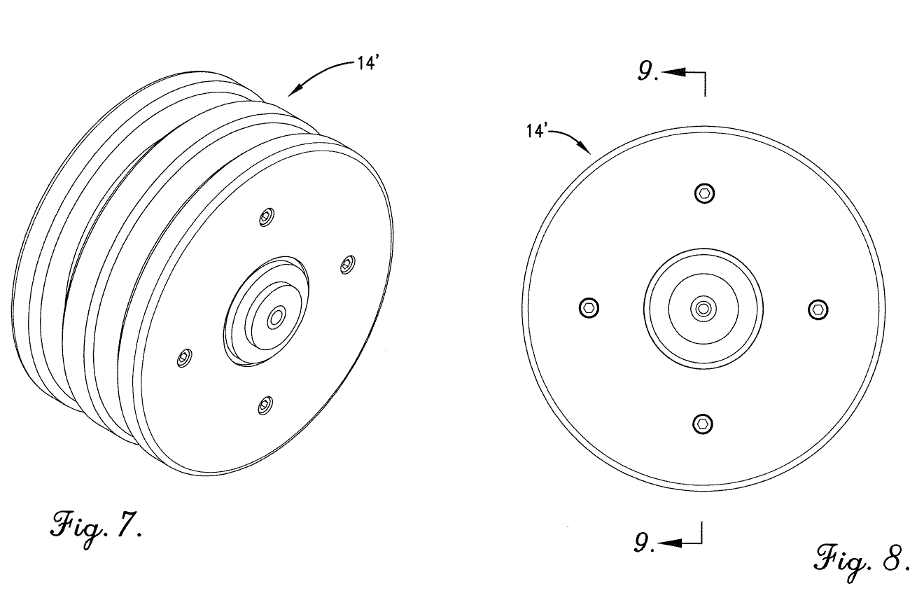

An alternate configuration of the first embodiment is illustrated in FIGS. 7 through 10, wherein the wheel 14′ is identically configured to the wheel 14 described above except that the spacer elements 54′ and 56′ are not integral with any of the discs 36,38′,40′ but are separate components. Each of the spacer elements 54′,56′ presents an elongated, cylindrical shape with a through hole for accommodating one of the bolts 52 or other fastener. Thus, the spacer elements 54′,56′ present a tubular shape defined by a cylindrical wall. The length of each of the spacer elements 54′,56′ may vary from one embodiment of the invention to another and depends, at least in part, on the amount of space desired between the discs.

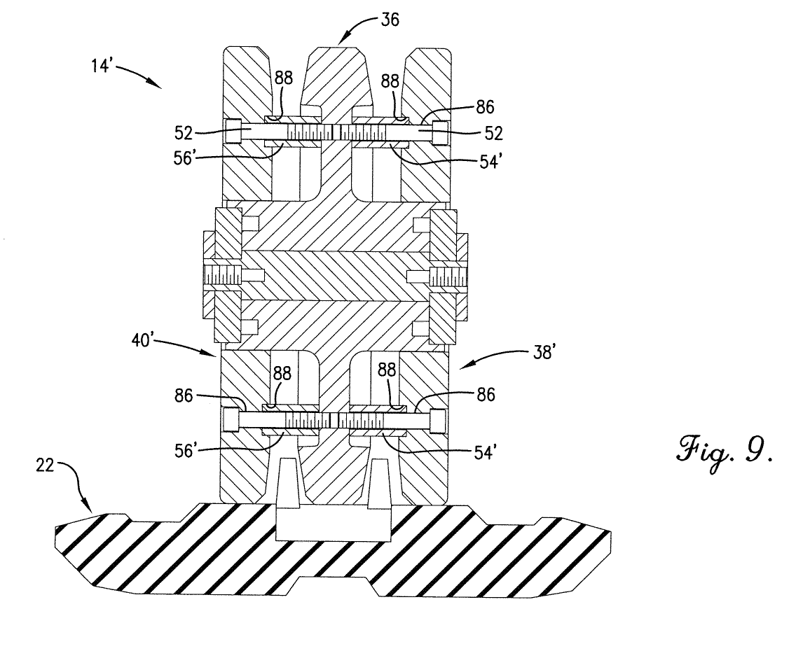

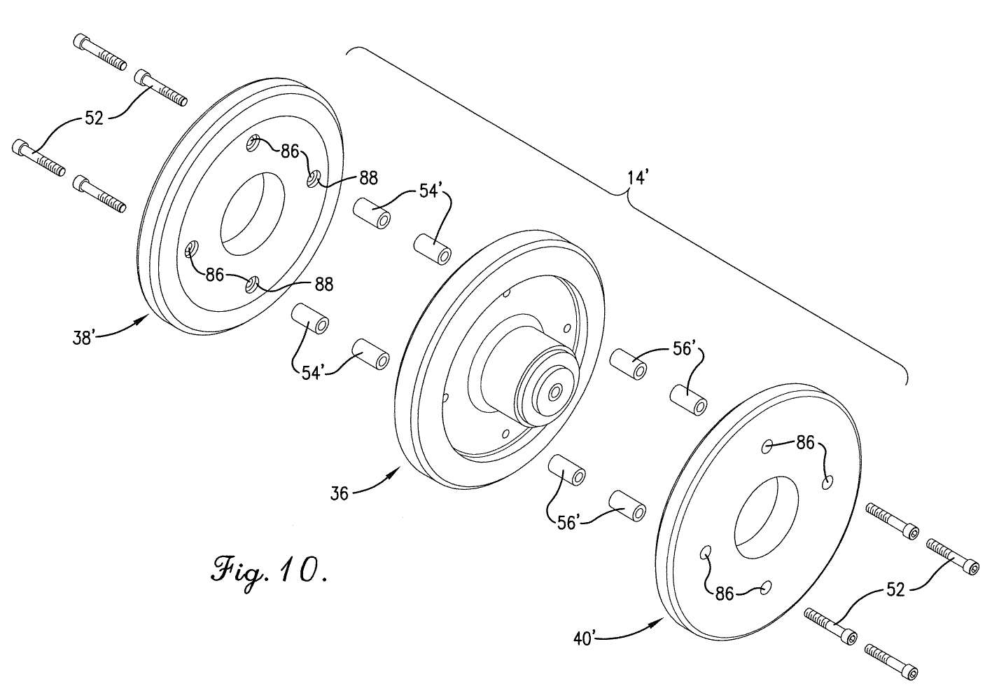

As illustrated in FIGS. 9 and 10, each of the second and third discs 38′,40′ includes a plurality of attachment through holes 86 corresponding to the location of the spacer elements 54′,56′, such that the bolts 52 may be inserted through the attachment through holes 86 and through the spacer elements 54′,56′ to engage the threaded recesses of the first disc 36. Each of the through holes 86 includes an annular recess 88 on a side of the disc facing the first disc 36. Each of the annular recesses 88 is concentric with the corresponding through hole 86 and configured to receive an axial end of one of the spacer elements 54′,56′, such that the when the wheel 14′ is assembled, each of the spacer elements 54′,56′ is seated in a corresponding annular recess 88. The wheel 14′ may be modified from an original wheel as described above with respect to the wheel 14, except that the spacer elements 54′,56′ must be interposed between the discs 36,38′,40′ as part of the assembly process.

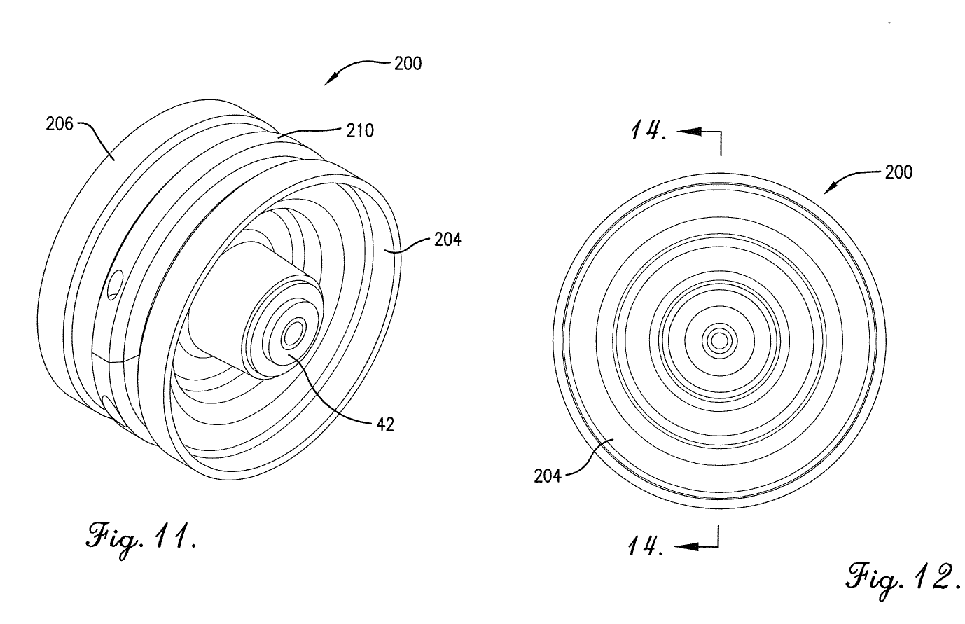

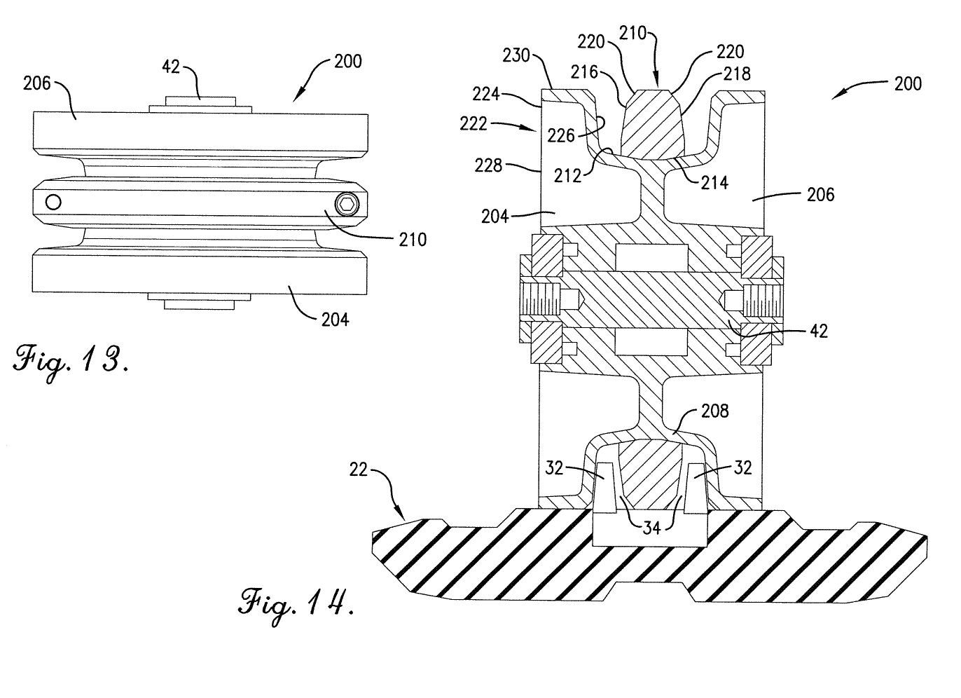

A track assembly wheel 200 constructed in accordance with a second embodiment of the invention is illustrated in FIGS. 11 through 15. The wheel 200 may be an idler wheel similar in position and function on the track assembly 10 to either of the idler wheels 14 or 16. The wheel 200 includes a unitary body 202 presenting a first disc section 204 corresponding to a first axial end of the wheel 200, a second disc section 206 corresponding to a second axial end of the wheel 200, and a narrowed neck portion 208 between the first disc section 204 and the second disc section 206 and separating the disc sections 204,206 by a space. The first disc section 204 and the second disc section 206 may be identically configured and oriented to be parallel and in axial alignment with one another.

Attached to the unitary body 202 is an annular element 210 positioned on the neck portion 208. The annular element 210 is not integrally formed with the unitary body 202 but is attached thereto, as explained below in greater detail. The annular element 210 may include a plurality of sections 210a,210b each at least partially circumscribing the neck portion 208 of the body 202. When the plurality of sections 210a,210b is assembled on the body 202, the annular element 210 circumscribes the neck portion 208. In the illustrated embodiment, the annular element 210 is a locking collar with two halves 210a,210b interconnected by a pair of bolts or other fasteners. Thus, the annular element 210 may be removably attached to the neck portion 208.

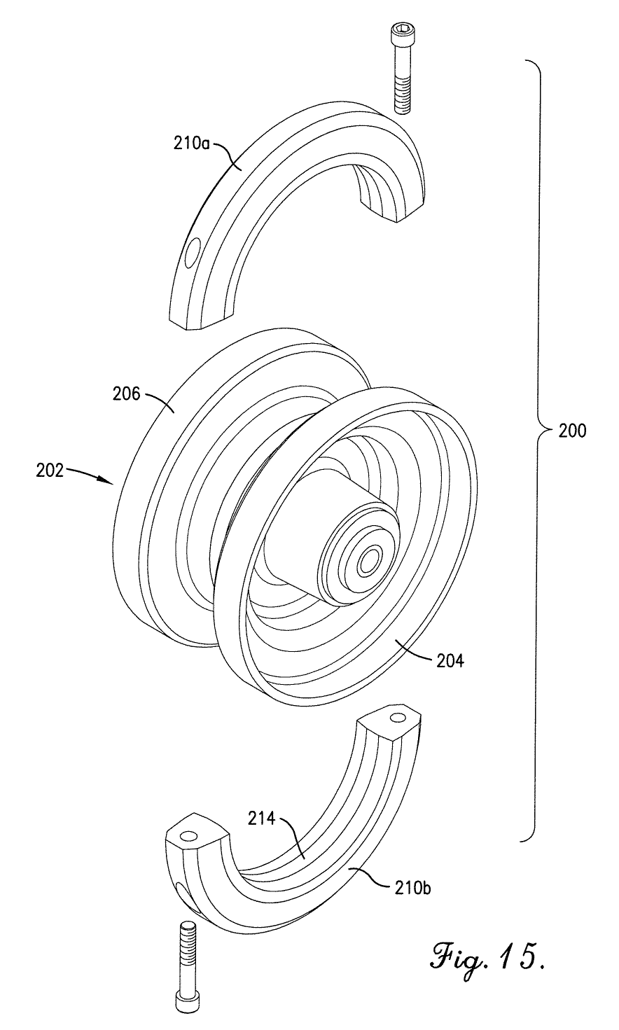

An outer surface 212 of the neck portion 208 may be slightly grooved or concave, as illustrated in FIG. 14, to firmly engage the annular element 210 and to prevent the annular element 210 from shifting laterally relative to the wheel 200 during operation. Furthermore, an inner surface 214 of the annular element 210 may be slightly convex to matingly engage the outer surface 212 of the neck portion 208.

Each of the disc sections 204,206 and the annular element 210 may be configured to facilitate engagement with the alignment mechanism 30 during operation of the track assembly 10. In the illustrated embodiment, each of the disc sections 204,206 includes a tapered radially outer side wall, a break edge, or both. The annular element 210 is tapered wherein each of a first lateral surface 216 and a second lateral surface 218 is sloped or angled inward from a radially inner edge to a radially outer edge such that a radially inner portion of the annular element is wider than a radially outer portion of the element. The annular element also includes opposing chamfered break edges 220 corresponding to radially outermost lateral edges of the annular element 210.

A radially outer portion 222 of the first disc section 204 presents a first, outer side 224 that is substantially straight and a second, inner side 226 that presents a slight inward slope or angle such that a base 228 of the radially outer portion 222 is wider than a tip 230 of the radially outer portion 222. A chamfered break edge 232 corresponds to a radially outermost edge adjacent the second, inner side 226. The second disc section 206 is configured similarly to the first disc section 204.

The wheel 200 is positioned on the track assembly 10 such that the annular element 210 engages the alignment mechanism 30 inside the channel 341, the first disc section 204 engages a first side of the alignment mechanism 30 outside the channel 34, and the second disc section 206 engages a second side of the alignment mechanism 30 outside the channel 34, in a manner similar to the wheel 14 described above.

In the illustrated embodiment the first 204 and second 206 disc sections and the annular element 210 are substantially uniform in diameter. It will be appreciated, however, that the relative diameter of the disc sections 204,206 and the annular element 210 will depend on the particular implementation and that the diameter of any of the first disc section 204, the second disc section 206, or the annular element 210 may vary without departing from the spirit or scope of the invention. By way of example, the annular element 210 may be larger or smaller in diameter than the first 204 and second 206 disc sections.

The wheel 200 may be modified from an existing wheel. In one embodiment of the invention, the wheel 200 is modified from a wheel originally manufactured and placed on the track assembly 10 with only the unitary body 202. The original wheel may be positioned on the track assembly 10 such that the first disc section 204 engages a first side of the alignment mechanism 30 and the second disc section 206 engages a second side of the alignment mechanism 30.

To modify the wheel 200, at least a portion of the wheel 200 is removed from the track assembly frame 12, wherein the removed portion includes at least the unitary body 202. Removing the wheel 200 from the track assembly frame 12 may include, for example, relieving tension on the track 22 allowing the track 22 to be disengaged from the wheel 14, removing a bolt or other fastener securing the shaft 42 to the frame 12, and removing the wheel 200 and shaft 42 from the track assembly 10. The annular element 210 is secured to the neck portion 208 of the body 202 by separating the sections 210a,210b of the annular element 210, placing the sections 210a,210b on the neck portion 208, and securing the sections 210a,210b in place using the fasteners.

The wheel 200 is then replaced on the track assembly frame 12 such that the annular element 210 engages the alignment mechanism 30 inside the channel 34, the first disc section 204 engages a first side of the alignment mechanism 30 outside the channel 34, and the second disc section 206 engages the alignment mechanism 30 outside the channel 34. Replacing the wheel 200 on the track assembly 10 may include placing the wheel 200 in its original position on the track assembly 10, replacing bolts or other fasteners to secure the transverse shaft 42 to the frame 12, replacing the track 22 in engagement with the wheel 200, and then applying tension to the track 22.

While the particular size and shape of the various components of the wheels described herein are not essential to the present invention, various exemplary dimensions and proportions will be provided for illustrative purposes. With reference to the wheel 14 (and corresponding elements of the wheels 14′ and 200), an outer diameter of each of the discs 36,38,40 is preferably within the range of from about five inches to about twenty-five inches, more preferably within the range of from about ten inches to about twenty inches, and may particularly be about fourteen inches, about fifteen inches, or about sixteen inches. A width of each of the discs 36,38,40 (excluding the neck portion of the first disc 36) is preferably within the range of from about one-half inch to about three inches, more preferably within the range of from about one inch to about two inches, and may particularly be about 1.4 inches, about 1.5 inches or about 1.6 inches. The attachment through holes 50 and the spacer elements 54,56 may be positioned on a circle that is concentric with the center of the wheel 14 and is located about one-half of the distance between the center of the wheel and an outer radius of the wheel, about two-thirds of the distance between the center of the wheel and an outer radius of the wheel, or about three-fourths of the distance between the center of the wheel and an outer radius of the wheel. Each of the spacer elements 54,56 presents a length that is preferably within the range of from about one inch to about four inches, more preferably within the range of from about two inches to about three inches, and that may particularly be about 2.25 inches, about 2.5 inches or about 2.75 inches.

The discs 36,38,40 may positioned on the wheel 14 such that the radially outer margin 60 of the first disc 36 is separated from the radially outer margin 72 of the second disc 38 and the radially outer margin 84 of the third disc 40 by a distance that is preferably within the range of from about one-half inch to about three inches, more preferably within the range of from about one inch to about two inches, and may particularly be about 1.4 inches, about 1.5 inches or about 1.6 inches.

It is also to be understood that the embodiments described herein are primarily directed to modifying or retrofitting an original equipment manufacture (OEM) wheel. However, it is to be understood that an OEM wheel could be manufactured having the structural features described herein, and that such OEM wheel is one of the inventive embodiments and aspects of the present invention.

Although the invention has been described with reference to the exemplary embodiments illustrated in the attached drawings, it is noted that equivalents may be employed and substitutions made herein without departing from the scope of the invention as recited in the claims. For example, while a plurality of cylindrical spacers have been illustrated and described, it will be appreciated that the spacers may present any of various shapes and that fewer or more spacers may be interposed between the discs. Furthermore, the machine 24 may be a compact track loader, bulldozer or other vehicle used in the construction or agricultural industries.

Having thus described various embodiments of the invention, what is claimed as new and desired to be protected by Letters Patent includes the following:

1. A method of modifying a track assembly wheel, the method comprising:
removing at least a portion of the wheel from the track assembly, the removed portion of the wheel including a first disc;
securing a second disc to the wheel on a first side of the first disc to create a modified track wheel; and
replacing the modified track wheel on the track assembly such that the wheel engages an alignment mechanism of the track, the wheel being positioned such that a portion of the alignment mechanism is between the first disc and the second disc such that the first disc engages a first side of the portion of the alignment mechanism and the second disc engages a second side of the portion of the alignment mechanism.

2. The method of claim 1, further comprising securing a third disc to the wheel on a second side of the first disc and replacing the modified track wheel on the track assembly such that the first disc engages the alignment mechanism inside a channel defined by the alignment mechanism, the second disc engages a first side of the alignment mechanism outside the channel, and the third disc engages a second side of the alignment mechanism outside the channel and opposite the first side of the alignment mechanism.

3. The method of claim 1, further comprising—
positioning the second disc such that a spacer element integrally formed in the second disc is interposed between the first disc and the second disc; and
positioning the third disc such that a spacer element integrally formed in the third disc is interposed between the third disc and the second disc.

4. The method of claim 2, further comprising—
securing a first spacer element between the first disc and the second disc; and
securing a second spacer element between the first disc and the third disc.

5. The method of claim 4, further comprising—
positioning the first spacer element in axial alignment with the second spacer element; and
securing the second disc and the third disc to the first disc by inserting at least one fastener through the spacer elements.

6. The method of claim 5, further comprising—
creating a threaded hole in the first disc such that the hole is in register with a through-hole of the first spacer element and a through-hole of the second spacer element; and
inserting at least one bolt through at least one of the spacer elements and into engagement with the threaded through hole.

7. The track assembly of claim 1, each of the first disc and the second disc presenting a tapered radially outer margin.

8. The method of claim 1, the wheel being an idler wheel with an outer diameter between ten inches and twenty inches.

9. The method of claim 8, further comprising replacing the wheel on the track assembly such that the wheel is at an end of the track assembly and defines an end curve of a path followed by the track.

10. A track assembly comprising:
a continuous track, the track including an alignment mechanism defining an inner longitudinal channel spanning at least a portion of the length of the track; and
a plurality of wheels engaging the track, at least one of the wheels including—
a unitary wheel body including a first disc section, a second disc section, and a neck portion, the first and second disc sections being in axial alignment and separated by the neck portion, and
an annular element not integrally formed with the unitary wheel body but attached to the neck portion such that the annular element is laterally separated from the first disc section by a space and is laterally separated from the second disc section by a space,
the wheel positioned on the track assembly such that the first disc section, the second disc section and the annular element engage the alignment mechanism, the annular element engaging the alignment mechanism inside the channel, the first disc section engaging a first side of the alignment mechanism outside the channel, and the second disc section engaging a second side of the alignment mechanism outside the channel, the second side of the alignment mechanism being opposite the first side of the alignment mechanism.

11. The track assembly of claim 10, the annular element being removably attached to the neck portion.

12. The track assembly of claim 11, the annular element including a locking collar comprising at least two portions, each portion partially circumscribing the neck portion.

13. The track assembly of claim 10, the annular element presenting an outer diameter that is equal to an outer diameter of the first disc section and an outer diameter of the second disc section.

14. The track assembly of claim 10, each of the first disc portion, the second disc portion, and the annular element presenting a tapered radially outer margin.

15. The track assembly of claim 10, the wheel being an idler wheel with an outer diameter between ten inches and twenty inches.

16. The track assembly of claim 15, further comprising replacing the wheel on the track assembly such that the wheel is at an end of the track assembly and defines an end curve of a path followed by the track.

17. A method of modifying a track assembly wheel, the method comprising:
removing at least a portion of the wheel from the track assembly, the removed portion of the wheel including a unitary body with a first disc section, a second disc section, and a neck portion separating the first disc section and the second disc section by a space;
securing an annular element to the neck portion of the body such that the annular element is laterally separate from the first disc section by a space and is laterally separated from the second disc section by a space;
replacing the modified track wheel on the track assembly such that the wheel engages a continuous track of the track assembly and an alignment mechanism of the track, the wheel being positioned such that the annular element engages the alignment mechanism inside the channel, the first disc section engages a first side of the alignment mechanism outside the channel, and the second disc section engages a second side of the alignment mechanism outside the channel.

18. The method of claim 17, the annular element presenting a tapered radially outer margin.

19. The method of claim 17, the wheel being an idler wheel with an outer diameter between ten inches and twenty inches.

20. The method of claim 19, further comprising replacing the modified track wheel on the track assembly such that the wheel is at an end of the track assembly and defines an end curve of a path followed by the track.
